(19) United States
(12) Patent Application Publication
(10) Pub. No.: US 2019/0122315 A1
(43) Pub. Date: Apr. 25, 2019

(54) Itinerary Portfolio Evaluation Tool

(71) Applicant: Amgine Technologies (US), Inc., Austin, TX (US)

(72) Inventors: L. James Valverde, JR., Washington, DC (US); Harold Roy Miller, Toronto (CA)

(21) Appl. No.: 16/142,834

(22) Filed: Sep. 26, 2018

Related U.S. Application Data
(60) Provisional application No. 62/574,533, filed on Oct. 19, 2017.

(51) Int. Cl. G06Q 50/14; G06F 17/30; G06Q 10/02

(52) U.S. Cl. CPC G06Q 50/14; G06Q 10/025; G06F 17/30554; G06F 17/30528

(57) ABSTRACT

Systems and methods for optimization-based travel itinerary planning are described herein. An example method may commence with receiving a travel-related query from a user and deriving, from the travel-related query, at least one attribute and at least one constraint related to the travel-related query. The method may continue with ranking the at least one attribute based on preferences data of the user. The method may further include assigning weights to the at least one attribute based on the ranking to create at least one weighted attribute. The method may continue with associating cost data with the at least one weighted attribute. Feasible travel itineraries may be scored based on the at least one weighted attribute and the cost data associated with the at least one weighted attribute. The method may further include selecting, from the feasible travel itineraries, an optimal travel itinerary based on the at least one constraint.

### CROSS-REFERENCE TO RELATED APPLICATION

The present utility patent application is related to and claims the priority benefit under 35 U.S.C. 119(e) of U.S. provisional application No. 62/574,533, filed on Oct. 19, 2017, and titled “ITINERARY PORTFOLIO EVALUATION TOOL.” The disclosure of this related provisional application is incorporated herein by reference for all purposes to the extent that such subject matter is not inconsistent herewith or limiting hereof.

### TECHNICAL FIELD

The present disclosure relates to data processing and, more particularly, to facilitating travel planning.

### BACKGROUND

Travel consumers enjoy a plurality of options. The travel market is replete with numerous sources providing travel-related information and advice on everything from destinations to hotels, related points of interest, and pricing data for a vast array of goods and services. While consumers can derive much utility from this choice environment enabled by online travel agencies (OTAs) and travel websites, a choice task of the travel consumer is often encumbered by information abundance, a myopic view of consumer choices, and legacy technology platforms that almost invariably complicate the consumer choice problem.

For the average consumer, these choice-related challenges can take many forms, which include a large number of viable itinerary options to sort through, evaluate, and ultimately choose from; disparate and non-homogenous information sources, all of which possess varying degrees of quality, usefulness, and reliability; and the need to consider complex value trade-offs among key choice attributes and objectives (e.g., price vs. suitability of a selected flight for the consumer), together with the existence of often conflicting objectives (e.g., a desire for luxury constrained by willingness-to-pay).

To overcome the choice-related challenges, average consumers typically utilize a vast array of short-cuts and heuristics, all of which enable the consumer to sift through and evaluate numerous choice options. This piecemeal, serial manner in which consumers typically construct, evaluate, and ultimately purchase travel itineraries (e.g., first, airfare options are reviewed and selections are made; this selection is followed, in turn, by the identification and evaluation of hotel options, and so on) can lead to undesirable allocative inefficiencies that stem from a kind of evaluative and decisional myopia that ultimately compromises the ability of the consumer to construe itinerary value holistically. In other words, delivering travel itinerary planning capabilities to the consumer needs to be redesigned to maximize the expected utility of individual consumers seeking to make travel-related purchases. Moreover, consumers need to be able to identify option combinations that create maximal overall utility or value, across the entire spectrum of available options, subject to any constraints deemed relevant to the itinerary construction, evaluation, and selection task.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented systems and methods for facilitating optimization-based travel itinerary planning. In some example embodiments, a system for facilitating optimization-based travel itinerary planning may include a processor and a database communicatively coupled to the processor and storing instructions executable by the processor. The processor may be configured to receive a travel-related query from a user and derive, from the travel-related query, at least one attribute related to the travel-related query and at least one constraint related to the travel-related query. The processor may be further configured to rank the at least one attribute based on preference data of the user. The processor may be further configured to assign weights to the at least one attribute based on the ranking to create at least one weighted attribute. The processor may be configured to associate cost data with the at least one weighted attribute. The processor may be configured to score feasible travel itineraries based on the at least one weighted attribute and the cost data associated with the at least one weighted attribute. The processor may be further configured to select, from the feasible travel itineraries, based on the at least one constraint, an optimal travel itinerary to be provided to the user.

According to some embodiments of the disclosure, a method for facilitating optimization-based travel itinerary planning may commence with receiving a travel-related query from a user. Upon receiving the travel-related query, at least one attribute related to the travel-related query and at least one constraint related to the travel-related query may be derived from the travel-related query. The method may continue with ranking the at least one attribute based on preference data of the user. The method may further include assigning weights to the at least one attribute based on the ranking to create at least one weighted attribute. The method may continue with associating cost data with the at least one weighted attribute. Feasible travel itineraries may be scored based on the at least one weighted attribute and the cost data associated with the at least one weighted attribute. The method may further include selecting, from the feasible travel itineraries, based on the at least one constraint, an optimal travel itinerary to be provided to the user.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for facilitating optimization-based travel itinerary planning can be implemented, according to an example embodiment.

FIG. 2 is a block diagram showing various modules of a system for facilitating optimization-based travel itinerary planning, in accordance with certain embodiments.

FIG. 3 is a process flow diagram showing a method for facilitating optimization-based travel itinerary planning, according to an example embodiment.

FIG. 4 illustrates a representation of an itinerary portfolio structure, according to an example embodiment.

FIG. 5 illustrates a graphical representation of values associated with each feasible travel itinerary, according to an example embodiment.

FIG. 6 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The disclosure relates to a system for facilitating optimization-based travel itinerary planning to aid consumer efforts directed at constructing value- or utility-maximizing travel itineraries, given some understanding of goals, objectives, and preferences of a consumer, together with an understanding of any constraints, such as budgetary, logical, timing, or other constraints. More specifically, the system brings a portfolio-analytic frame to an itinerary choice task of the travel consumer. The purpose of the system is to identify Pareto efficient itinerary options that maximize overall itinerary value for the consumer and are consistent with specified constraints. By making the travel planning process more efficient, the likelihood of consumer ex post purchase satisfaction may increase because of enhanced decision quality provided to the consumer.

The system may act as a decision framework that provides a structural basis for travel itinerary planning and is capable of supporting the evaluative challenges entailed in identifying the itinerary option combinations that maximize or enhance overall itinerary value for the consumer. Moreover, the system provides an analytic decision frame that brings a holistic orientation to how problems of allocative efficiency are approached within the context of the itinerary choice task.

In the present disclosure, a user may provide a travel-related query to the system. The system may analyze the travel-related query to derive attributes associated with the travel-related query and constraints related to the travel-related query. The attributes may include itinerary elements, such as airlines, hotel options, dates, and so forth. The constraints may include budgetary constraints, timing constraints, logical constraints, and so forth. Upon deriving the attributes, the system may rank the attributes of the travel-related query based on preference data of the user. Based on the ranking, weights may be assigned to each of the attributes to obtain weighted attributes. Furthermore, the system may associate each of the weighted attributes with cost data related to each of the weighted attributes. The system may perform multiparameter scoring of feasible travel itineraries. Specifically, the feasible travel itineraries may be simultaneously scored based on the weighted attributes and the cost data associated with the weighted attributes. Upon the scoring, at least one optimal travel itinerary may be selected from the feasible travel itineraries based on the constraints associated with the travel-related query. The selected optimal travel itinerary may be presented to the user.

A plurality of feasible travel itineraries is also referred to herein as an itinerary portfolio group. The itinerary portfolio group may be structured hierarchically in terms of one or more itinerary categories or groups, i.e., attributes related to the travel-related query. The itinerary portfolio group can describe typical itinerary elements of the itinerary, such as flights, hotel options, and the like, as well as other attributes, such as ground transportation options, tours, and so forth. Each itinerary portfolio group may contain a constructed choice set of determinate size, and each choice set may consist of options that pertain to the itinerary portfolio group to which the choice set belongs.

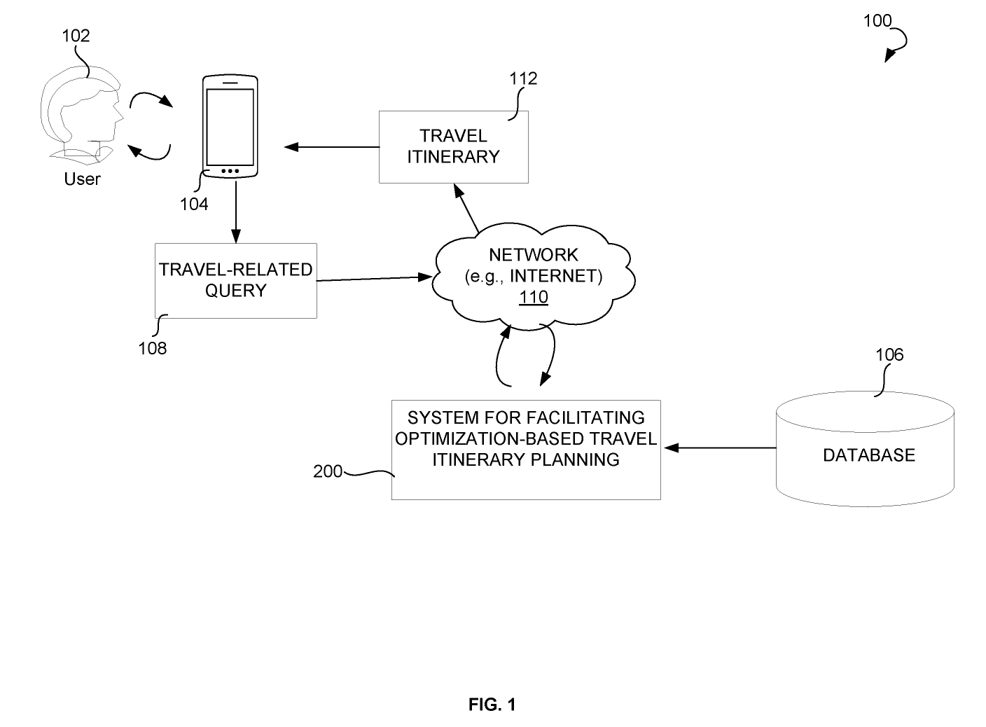

FIG. 1 illustrates an environment 100 within which systems and methods for facilitating optimization-based travel itinerary planning can be implemented, in accordance with some embodiments. The environment 100 may include a user 102, a user device 104, a system 200 for facilitating optimization-based travel itinerary planning (also referred to as a system 200), a data network 110 (e.g., the Internet or a computing cloud), and optionally a database 106. The user device 104, the system 200, and the database 106 may be connected via the data network 110.

A travel-related query 108 of the user 102 may be received, for example, via a user interface displayed on the user device 104. The travel-related query 108 may include text data. The text data may be obtained by transcribing a natural language input of the user 102, by speech-to-text conversion of an oral exchange with the user 102, or otherwise. In some embodiments, the user 102 may be asked, orally, one or more motivating questions in order to receive relevant travel-related query 108.

The travel-related query 108 may be transmitted to the system 200 via the network 110. The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network can further include or interface with any one or more of an RS-232 serial connection, an IEEE-1394 (FireWire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may be a network of data processing nodes that are interconnected for the purpose of data communication. The network 110 may include any suitable number and type of devices (e.g., routers and switches) for forwarding commands, content, and/or requests from each user 102 to the system 200 and responses back to the user 102.

The user device 104, in some example embodiments, may include a Graphical User Interface for displaying the user interface associated with the system 200. The user device 104 may include a mobile telephone, a personal computer (PC), a laptop, a smartphone, a tablet PC, and so forth. The system 200 may include a server-based distributed application, thus the system 200 may include a central component residing on a server and one or more client applications residing on one or more user devices and communicating with the central component via the network 110. The user 102 may communicate with the system 200 via a client application available through the user device 104.

Travel itineraries available, for example, from the database 106 may be analyzed based on preference data of user 102 and, in some embodiments, preference data of one or more further users. At least one travel itinerary 112 may be selected by the system 200 and presented to the user 102 by displaying the travel itinerary 112 via the user interface on a screen of the user device 104.

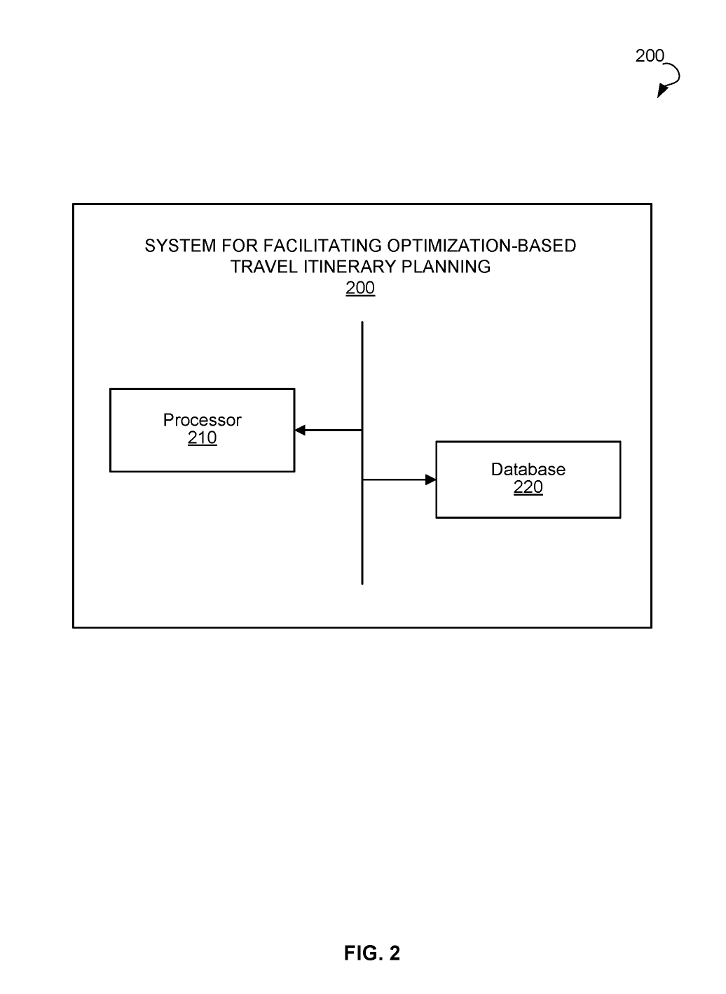

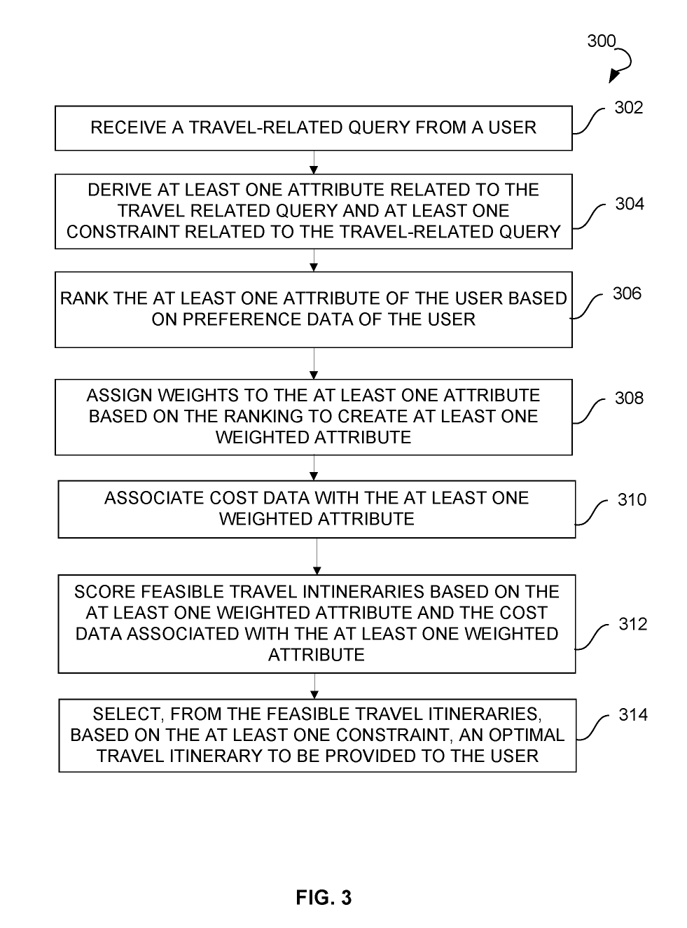

FIG. 2 is a block diagram showing various modules of a system 200 for facilitating optimization-based travel itinerary planning, in accordance with certain embodiments. The system 200 may include a processor 210 and a database 220. The database 220 may include computer-readable instructions for execution by the processor 210. The processor 210 may include a programmable processor, such as a microcontroller, central processing unit (CPU), and so forth. In other embodiments, the processor 210 may include an application-specific integrated circuit or programmable logic array, such as a field programmable gate array, designed to implement the functions performed by the system 200. In various embodiments, the system 200 may be installed on a user device or may be provided as a cloud service residing in a cloud storage. The operations performed by the processor 210 and the database 220 are described in detail with reference to FIG. 3.

FIG. 3 is a process flow diagram showing a method 300 for facilitating optimization-based travel itinerary planning within the environment described with reference to FIG. 1. In some embodiments, the operations may be combined, performed in parallel, or performed in a different order. The method 300 may also include additional or fewer operations than those illustrated. The method 300 may be performed by processing logic that may comprise hardware (e.g., decision making logic, dedicated logic, programmable logic, and microcode), software (such as software run on a general-purpose computer system or a dedicated machine), or a combination of both.

The method 300 may commence with receiving a travel-related query at operation 302. In an example embodiment, the travel-related query may be provided via at least one of the following: a natural language, a typed text, a selection of preexisting options, and so forth. In a further embodiment, the travel-related query may be associated with a group of users.

The method 300 may continue with deriving, from the travel-related query, at least one attribute related to the travel-related query and at least one constraint related to the travel-related query at operation 304. Specifically, the method 300 may include parsing the travel-related query to derive the at least one attribute and at least one constraint related to the travel-related query. In some embodiments, a constraint may include a budgetary constraint, a logical constraint, a conditional constraint, a timing constraint, and the like. In an example embodiment, a plurality of attributes, i.e., an attribute set relevant to the travel-related query, may be derived. The attributes may include parameters of the itinerary, such as a flight, a hotel, an origin city, a destination city, a departure date, an arrival date, time, prices, travel class, and other attributes, such as ground transportation options, tours, and the like. Each attribute may have an option. For example, the options for the ‘hotel’ attribute may include ‘hotel 1’ in a destination city, ‘hotel 2’ in the destination city, and any other hotels that may satisfy the travel-related query.

In an example embodiment, the at least one attribute with one possible value is a necessarily satisfied condition. In other words, the user may need to provide at least one attribute of the travel-related query.

The at least one attribute may be ranked based on preferences data of the user at operation 306. In an example embodiment, the preferences example of the user may be determined based on the travel-related query. In another example embodiment, the preferences example may be determined based on preexisting selections associated with the user or preexisting selections associated with one or more further users.

The method 300 may optionally comprise providing a man-machine interface to receive the preexisting selections from the user. More specifically, the method 300 may include a front-end instantiation of preferences data of the user, where the preferences data are obtained by parsing the semantic intent underlying the travel-related query. The method 300 may further include a back-end specification of the preferences data of the user by reading user-specified rank-order preference information (i.e., the preexisting selections) from a database (for example, the preference information related to airlines, hotels, etc.).

The method 300 may continue by assigning weights to the at least one attribute based on the ranking at operation 308. Thus, at least one weighted attribute may be created. The method 300 may include associating cost data with the at least one weighted attribute at operation 310. Specifically, each specific weighted attribute may be associated with cost data related to this specific weighted attribute.

The method 300 may include scoring feasible travel itineraries based on the at least one weighted attribute and the cost data associated with the at least one weighted attribute at operation 312. Upon the scoring, an optimal travel itinerary may be selected from the feasible travel itineraries based on the at least one constraint at operation 314. Specifically, the optimal travel itinerary may be selected from the feasible travel itineraries based on the scoring of the feasible travel itineraries. The optimal travel itinerary may be presented to the user via a user device.

In an example embodiment, the method 300 may further include ranking the feasible travel itineraries based on the scoring and selecting one or more further optimal travel itineraries to be provided the user. The one or more further optimal travel itineraries may be selected from the feasible travel itineraries based on the ranking. In other words, one or more top feasible travel itineraries in a ranked list of feasible travel itineraries may be presented to the user.

In an example embodiment, the method 300 may be include identifying at least one of the feasible travel itineraries for which a budget allocation is unutilized. The budget allocation may be associated with the at least one constraint. Specifically, the budget allocation may include a cost of the itinerary indicated by the user in the travel-related query. In other words, the at least one of the feasible travel itineraries the cost of which is lower than the cost of the itinerary indicated by the user may be identified. The method 300 may further include presenting the at least one of the feasible travel itineraries for which the budget allocation is unutilized to the user.

The operations of the method 300 shown on FIG. 3 and elements of the system 200 for facilitating optimization-based travel itinerary planning shown on FIG. 2 are further described in detail below.

In an example embodiment, a typical consumer may construct an itinerary portfolio, also referred herein to as a travel itinerary portfolio, by constructing sets of choices using the system 200. Specifically, the itinerary portfolio may include a set of attributes of the travel itinerary. The process of constructing the itinerary portfolio using the system 200 may consist of the steps of (i) specification of the individual choice sets that correspond to the desired and/or relevant attributes of the itinerary; (ii) multiattribute valuation and costing of individual choice set options; and (iii) specification of relevant constraints. Completing this set of steps may provide a numerically specified itinerary portfolio, which may be amenable to numerical evaluation and analysis. In possession of the enumerated itinerary portfolio, the system 200 may identify itinerary portfolio allocations, i.e., a specific combination of choices across all of the attributes contained in a given portfolio with one option selected from each choice set, that maximize a value of the itinerary portfolio value for a specified constraint of the customer, such as a budget. The value of the itinerary portfolio may include a multiattribute score related to the travel itinerary and determined by scoring feasible travel itineraries based on the weighted attributes of the travel itinerary and the cost data associated with each of the weighted attributes.

Identification and Specification of Individual Choice Sets

In a travel-specific example, a consumer, who is a business traveler, plans to travel by himself on a two-day/one-night trip that has one destination. The following six itinerary portfolio groups, i.e., attributes of the travel-related query, are deemed as most relevant to the travel planning process of the consumer:

Ground transportation options from a home of the consumer to an origin airport;

Outbound flight itinerary options;

Ground transportation options at a destination city;

Hotel options at the destination city;

Return flight itinerary options;

Ground transportation options from the airport to the home of the consumer.

The system 200 may specify the choice sets that correspond to each of these itinerary portfolio groups.

Let A denote the set of ground transportation options that the consumer wishes to consider for getting from the consumer from home to the origin airport:

A={a₁, a₂, a₃, a₄},

where
a₁=Subway;
a₂=Uber-Regular;
a₃=Taxi;
a₄=Uber-Black.

Let B denote the set of outbound flight options that the consumer wishes to consider:

B={b₁, b₂, b₃, b₄, b₅},

where
b₁=Cheapest (2-stops);
b₂=Economy (1-stop);
b₃=Economy (non-stop);
b₄=Economy⁺ (non-stop);
b₅=Business Class (non-stop).

Let C denote the set of options that the consumer wishes to consider as ground transportation alternatives at her destination city:

C={c₁, c₂, c₃},

where
c₁=User Taxi;
c₂=Use Uber-Regular;
c₃=Procure a Rental Car.

Let D denote the set of hotel accommodation options that the consumer wishes to consider at her destination city:

D={d₁, d₂, d₃, d₄},

where
d₁=3-Star Chain;
d₂=4-Star Chain;
d₃=4-Star Boutique (flash sale);
d₄=5-Star Boutique.

Let E denote the set of return flight options that the consumer wishes to consider:

E={e₁, e₂, e₃, e₄, e₅},

where
e₁=Cheapest (2-stops);
e₂=Economy (1-stop);
e₃=Economy (non-stop);
e₄=Economy⁺ (non-stop);
e₅=Business Class (non-stop).

Finally, let F denote the set of ground transportation options that the consumer wishes to consider for her return home from the airport:

F={f₁, f₂, f₃, f₄},

where
f₁=Subway;
f₂=Uber-Regular;
f₃=Taxi;
f₄=Uber-Black.

Multiattribute Valuation and Costing of Options

The system 200 may assign determinate multiattribute scores to the individual choice set options described above along with providing determinate cost estimates for each option.

Choice Set A.

Among the four options that the consumer considers within this particular choice set, the subway options is by far the cheapest, but provides the consumer the least utility, owing mainly to its lack of convenience, the need to allow for additional time to get to the subway station, and the fact that the consumer need to physically carry the luggage to the subway station. The Uber option is preferred over the taxi option, due mainly to cost and convenience considerations. Finally, the Uber-Black option is the priciest option, but it provides the consumer the greatest level of utility, due mainly to the tangible benefits that the consumer derives from the luggage handling and the overall level of service. These preferences and judgements are represented numerically in the vector shown below, together with the relevant cost data associated with the options considered in this choice set:

A: [(0.3; $4:50); (0.6; $30); (0.45; $37); (0.9; $47)];

where each ordered pair contains the aggregate multiattribute score and the determinate cost value, respectively, for each aᵢ ∈ A, for i=1, . . . , 4. A similar notation is used for the choice set values described below.

Choice Set B.

The measurable value function used for this decision category follows a fairly linear progression in its treatment of performance vs. price:

B: [(0.2; $299); (0.45; $450); (0.6; $535); (0.7; $600); (0.95; $800)].

Choice Set C.

In valuing the options contained in this choice set, the consumer appraises the tradeoffs between benefit versus cost. Looking at the three options contained in this choice set, the consumer may note that the taxi is almost always readily available in the city the consumer is traveling to, but is, on average, slightly more expensive than using Uber. This latter option, though, may typically entail a wait time of some (unknown) duration, and may sometimes even require the consumer to meet the driver at a convenient intersection. The rental car option has some attraction, but also comes with hassles for the consumer, for example, picking up and dropping-off the rental vehicle near the airport, as well as the additional cost and hassle of finding public parking, etc.:

C: [(0.3; $300); (0.6; $280); (0.75; $373)].

Choice Set D.

The measurable value function used here is, for the most part, linear in its treatment of performance versus price. For option d₃, however, the value function captures the fact that the price savings inherent to this option come with a specific risk, namely, the consumer lacks first-hand familiarity with this particular hotel property, and therefore values that option slightly less than its “known” counterpart:

D: [(0.3; $350); (0.6; $475); (0.56; $425); (0.9; $550)].

Choice Set E.

The measurable value function of choice set E is similar to the one used for choice set B, but, nevertheless, admits the possibility that differences may exist for the preferences of the consumer concerning outbound versus return flight itineraries. Accordingly, for this example, the higher performing options are scored higher than they were for choice set B, owing to the fact that the consumer envisions being tired after meetings of the consumer, and is likely to value the higher level of service more than in the case of the outbound flight:

E: [(0.1; $299); (0.45; $450); (0.7; $535); (0.8; $600); (0.95; $800)].

Choice Set F.

Similar to the situation described above for choice set E, the consumer envisions that a state of mind of the consumer may be such that lower performing options are less desirable to the consumer in the latter portion of the trip than they were for the outbound portion. Similarly, the taxi option is also valued less than before, in anticipation of possibly long lines and/or wait times for a taxi in the late evening of the anticipated arrival of the consumer back home:

F: [(0.2; $4:50); (0.65; $30); (0.3; $37); (0.9; $47)].

Specification of Constraints—Budgetary and Otherwise

In the travel-specific example above, budget may be the constraint with which the consumer is most concerned. The total budgeted amount for the purchase of an entire travel itinerary is denoted by C. C can be constructed as the sum total of r individually specified budget constraints, where r is the total number of decision groups under consideration by the consumer. Another type of constraint is how each individual portfolio group is treated within the overall context of an itinerary portfolio evaluation. In the travel-specific example above, it can be assumed that the consumer selects one (and only one) option from the constructed choice set associated with each portfolio group. In other embodiments, this assumption can be relaxed to make such choices optional (for example, the system 200 may dictate that an option from a given portfolio group is included in a feasible portfolio allocation if its inclusion maximizes the objective function of the consumer and the option satisfies all of the relevant and/or specified constraints). In another embodiment, the constraints imposed can be made explicitly conditional, so that a given option (or a set of options) may be only selected if certain logical conditions are met. For example, the consumer may consider the purchase of a spa package, which is only available for purchase if the consumer stays at a particular hotel. Such conditions can take many forms, e.g., either-or constraints, K-out-of-N constraints, and so forth.

Itinerary Portfolio Evaluation—Optimization Approach

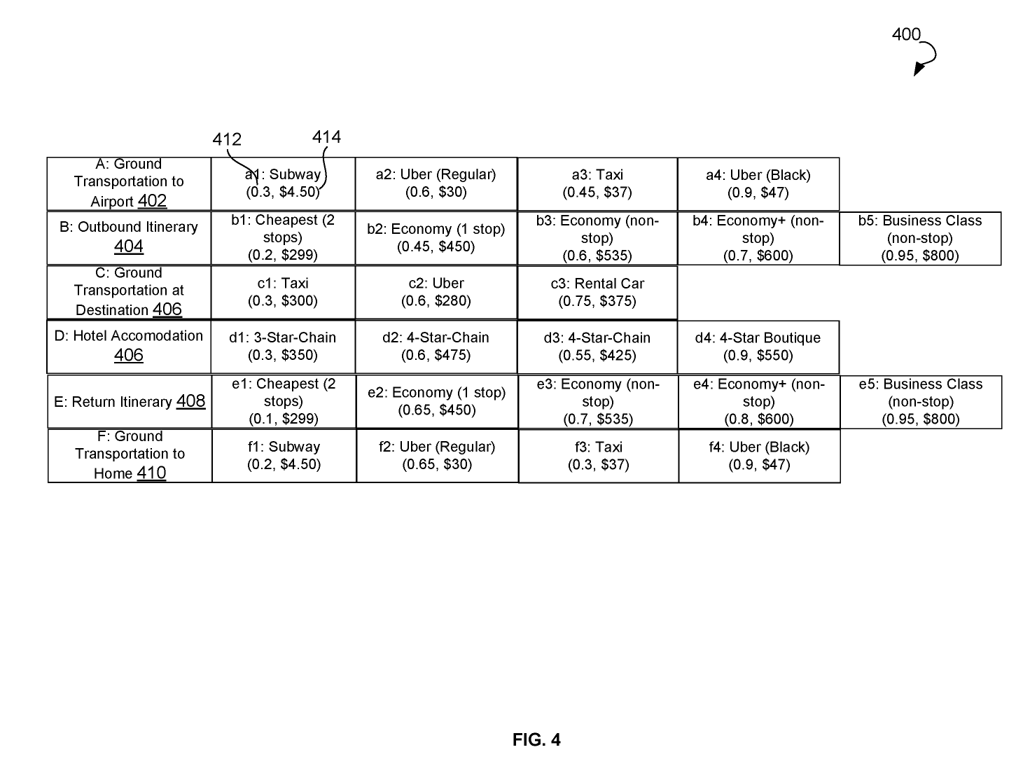

Having fully specified and enumerated the itinerary portfolio, the system 200 can numerically evaluate the portfolio to explore the prescriptive implications of the itinerary portfolio evaluation. The system 200 can structure the numerically evaluated portfolio in a visual representation, such as in FIG. 4. FIG. 4 is a schematic diagram 400 illustrating an itinerary portfolio structure, according to an example embodiment. In FIG. 4, each of rows 402, 404, 406, 408, and 410 corresponds to the portfolio groups also referred to as attributes. Within each portfolio group—labeled A, B, C, D, F—the individual options associated with each choice set are depicted, as well as the value 412 (i.e., the score based on the weighted attribute) and cost data 414, providing the consumer with a quick at-a-glance view of the entire itinerary decision space under consideration.

Using the itinerary decision space of FIG. 4, the system 200 may identify portfolio allocations that represent greatest overall value for the consumer, consistent with the articulated goals, objectives, preferences, and constraints of the consumer. For example, suppose that the consumer wishes to select one option from each of the six portfolio groups described above in such a way that the itinerary value is maximized and that her total itinerary cost does not exceed $1,900.

The system 200 may analyze the specified set of values yielding the following optimal portfolio allocation:

(a₄; b₁; c₃; d₄; e₃; f₄).

This particular portfolio allocation yields an itinerary portfolio value of 4.35, for a total cost to the consumer of $1,853—just shy of the $1,900 budget constraint specified by the consumer.

In another example embodiment, the consumer may wonder how changes in the available budget may affect the itinerary prescriptions for the trip of the consumer. The system 200 may iteratively analyze itineraries across a range of possible budget constraints and identify an optimal itinerary at each constraint. For example, the consumer may wish to consider a finite set of possible budget constraints, ranging from $1,300 to $2,800, in increments of $100. The optimal itinerary portfolio allocations derived by the system 200 from the iterative process are shown in Table 1:

| Budget | Max. value | Attributes | Cost |
|---|---|---|---|
| $1300 | 2.45 | (a1, b1, c2, d1, e1, f2) | $1,288 |
| $1400 | 3.25 | (a4, b1, c2, d3, e1, f4) | $1,397 |
| $1500 | 3.40 | (a4, b1, c3, d3, e1, f4) | $1,492 |
| $1600 | 3.65 | (a4, b1, c2, d2, e2, f4) | $1,598 |
| $1700 | 3.95 | (a4, b1, c2, d4, e2, f4) | $1,673 |
| $1800 | 4.20 | (a4, b1, c2, d4, e3, f4) | $1,758 |
| $1900 | 4.35 | (a4, b1, c3, d4, e3, f4) | $1,853 |
| $2000 | 4.60 | (a4, b3, c2, d4, e3, f4) | $1,994 |
| $2100 | 4.75 | (a4, b3, c3, d4, e3, f4) | $2,089 |
| $2200 | 4.85 | (a4, b3, c3, d4, e4, f4) | $2,154 |
| $2300 | 4.95 | (a4, b4, c3, d4, e4, f4) | $2,219 |
| $2400 | 5.10 | (a4, b5, c3, d4, e3, f4) | $2,354 |
| $2500 | 5.20 | (a4, b5, c3, d4, e4, f4) | $2,419 |
| $2600 | 5.20 | (a4, b5, c3, d4, e4, f4) | $2,419 |
| $2700 | 5.35 | (a4, b5, c3, d4, e5, f4) | $2,619 |
| $2800 | 5.35 | (a4, b5, c3, d4, e5, f4) | $2,619 |

Table 1 provides a basis for bringing value-for-money considerations into decision making calculus concerning the selection of itinerary elements. For each specified budget constraint, the feasible itinerary portfolio allocation is Pareto efficient, in the sense that (i) for each itinerary portfolio, there does not exist a better performing portfolio for less cost; and (ii) for each $100 incremental addition to the budget constraint, the prescribed itinerary portfolio allocation represents the best possible use of additional capital.

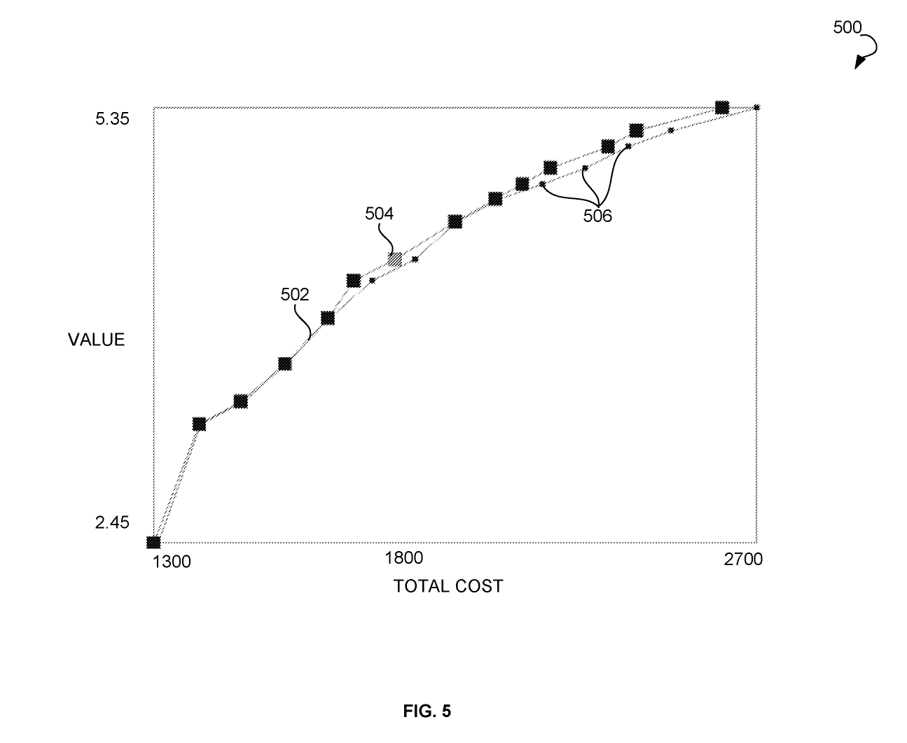

FIG. 5 depicts a graphical representation 500 of a Pareto-type curve 502, according to an example embodiment. For the Pareto-type curve 502, the values associated with each optimal itinerary portfolio allocation are taken and value versus cost are plotted. The Pareto curve 502 plots 14 optimal itinerary portfolios of Table 1 (leaving out the two portfolios—$2,600 and $2,800—that do not yield an improvement in portfolio value), and reveals several insights. First, as indicated earlier, each point depicted on the Pareto-type curve 502 is Pareto efficient, in the sense that, for the specified budget constraint, the itinerary portfolio value represents maximal value for the consumer, i.e., the itinerary value cannot be bettered for less cost. Second, for this particular itinerary portfolio specification, the consumer begins to reach diminishing returns somewhere around the $1,800-1,900 mark (shown by element 504). At the same time, it can be noted that the consumer achieves greatest value-for-money between $1,300-1,700. In the Pareto-type curve 502, elements 506 located to the right of some of the itinerary portfolios indicate those portfolio allocations where the entire budget allocation is not utilized (within some specified percentage; for example, instances where more than 3% of the budget allocations goes unutilized are noted by the elements 506).

Both Table 1 and FIG. 5 provide consumers with a number of valuable decision-aiding insights. The system 200 allows consumers to rule out numerous possible itinerary choices that under-perform relative to better performing portfolio allocations that the system 200 identifies, and that are seen to lie along the Pareto efficient frontier. The analysis performed by the system 200 may provide consumers with prescriptive guidance and direction as to where “biggest bang-for-their-buck” is had within a specified itinerary portfolio. The system 200 is also capable of revealing the inverse situation, i.e., instances where the consumer may—to the extent that the Pareto analysis reveals that diminishing marginal returns have been reached within a given portfolio specification—possibly be overspending (in the sense that the consumer sees little, if any, additional value for each additional incremental expenditure of capital). The practical insights provided by the system 200 aid the consumer's efforts—within the overall context of the travel planning process to arrive at a requisite decision state in the most efficient manner possible.

The system 200 may utilize integer programming (IP) to optimize travel itineraries. IPs represent a broad class of constrained optimization problems where some or all of the variables are integers, and where the objective function and constraints are typically linear. In some embodiments, knapsack problem (KP) models or multiple choice knapsack problem (MCKP) models, which are specific classes of IPs, are utilized within the system.

An MCKP model used within the system 200 is formally stated as follows:

$$\begin{matrix}Maximize \text{:} {\sum }_{t ∈ K} {\sum }_{j = 1}^{{n}_{t}} {b}_{tj} {x}_{tj} & ( 1 ) \\ Subject to \text{:} {\sum }_{t ∈ K} {\sum }_{j = 1}^{{n}_{t}} {c}_{tj} {x}_{tj} \leq d & ( 2 ) \\ {\sum }_{j = 1}^{{n}_{t}} {x}_{tj} = 1 t ∈ K = \{ 1 , 2 , … , κ \} \\ {x}_{tj} ∈ \{ 0 , 1 \} t ∈ K , j ∈ {S}_{t} = \{ 1 , 2 , … , {n}_{t} \} \\ {b}_{tj} , {c}_{tj} , d \geq 0 , {c}_{tj} < d , t ∈ K , j ∈ {S}_{t} & ( 3 )\end{matrix}$$

where the itinerary portfolio is assumed to consist of κ categories or groups. Associated with each category t, where t ∈ K={1, 2, . . . , κ}, is a choice set that consists of nₜ options. In this model, exactly one option is selected from each choice set. In some embodiments, exactly one option is required to be selected from each choice set. The cost and the multiattribute score associated with each option j, j ∈ Sₜ={1, 2, . . . , nₜ}, in category t, are assessed as cₜⱼ and bₜⱼ, respectively. The total budget to be allocated across all κ categories is capped by a fixed, determinate allocation, d. Finally, the decision variables in the model are defined as xₜⱼ=1, if option j (j ∈ Sₜ), in choice set t (t ∈ K), is selected, or as xᵢⱼ=0, otherwise.

Equation (1) computes the overall value of a given itinerary portfolio allocation (a value to be maximized); Equation (2) represents a constraint commonly referred to as the resource constraint or budget constraint. The constraints that are given by Equation (3) are commonly referred to as the multiple choice constraints. Finally, consistent with the previous usage and overall formulation, sets Sₜ, t ∈ K, shall be referred to as the choice sets that collectively comprise a given itinerary portfolio.

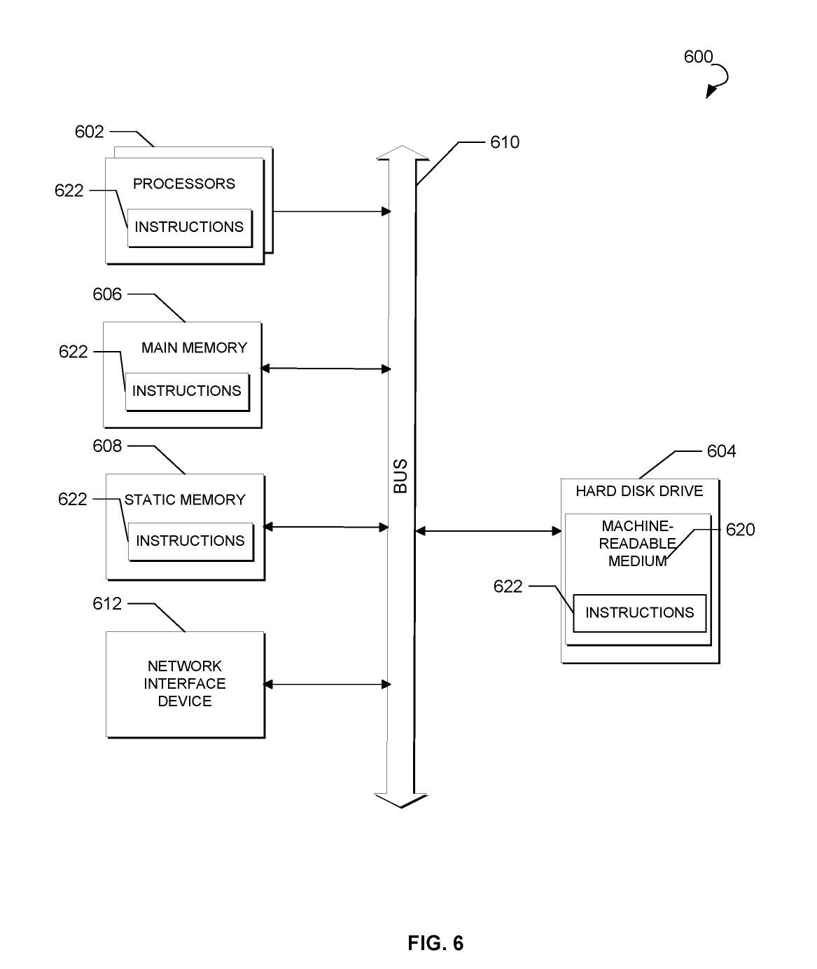

FIG. 6 shows a diagrammatic representation of a computing device for a machine in the exemplary electronic form of a computer system 600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602, a hard disk drive 604, a main memory 606, and a static memory 608, which communicate with each other via a bus 610. The computer system 600 may also include a network interface device 612. The hard disk drive 604 may include a computer-readable medium 620, which stores one or more sets of instructions 622 embodying or utilized by any one or more of the methodologies or functions described herein. The instructions 622 can also reside, completely or at least partially, within the main memory 606 and/or within the processors 602 during execution thereof by the computer system 600. The main memory 606 and the processors 602 also constitute machine-readable media.

While the computer-readable medium 620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 600 may be implemented as a cloud-based computing environment, such as a virtual machine operating within a computing cloud. In other embodiments, the computer system 600 may itself include a cloud-based computing environment, where the functionalities of the computer system 600 are executed in a distributed fashion. Thus, the computer system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Thus, computer-implemented methods and systems for facilitating optimization-based travel itinerary planning are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for facilitating optimization-based travel itinerary planning, the system comprising:
a processor configured to:
receive a travel-related query from a user;
derive, from the travel-related query, at least one attribute related to the travel-related query and at least one constraint related to the travel-related query;
rank the at least one attribute based on preference data of the user;
assign weights to the at least one attribute based on the ranking to create at least one weighted attribute;
associate cost data with the at least one weighted attribute;
score feasible travel itineraries based on the at least one weighted attribute and the cost data associated with the at least one weighted attribute; and
select, from the feasible travel itineraries, based on the at least one constraint, an optimal travel itinerary to be provided to the user; and
a database communicatively coupled to the processor, the database storing instructions executable by the processor.

2. The system of claim 1, wherein the processor is further configured to:
parse the travel-related query, wherein the at least one attribute and at least one constraint are derived from the travel-related query based on the parsing.

3. The system of claim 1, wherein the travel-related query is provided via at least one of the following: a natural language, a typed text, and a selection of preexisting options.

4. The system of claim 1, wherein the processor is further configured to determine the preference data of the user based on one or more of the following: the travel-related query, preexisting selections associated with the user, and preexisting selections associated with one or more further users.

5. The system of claim 4, wherein the processor is further configured to provide a man-machine interface to the user to receive the preexisting selections from the user.

6. The system of claim 1, wherein the travel-related query is associated with a group of users.

7. The system of claim 1, wherein the at least one constraint includes one or more of the following: a budgetary constraint, a logical constraint, a conditional constraint, and a timing constraint.

8. The system of claim 1, wherein the selecting of the optimal travel itinerary from the feasible travel itineraries is further based on the scoring of the feasible travel itineraries.

9. The system of claim 8, wherein the processor is further configured to:
rank the feasible travel itineraries based on the scoring; and
select one or more further optimal travel itineraries to be provided to the user, the one or more further optimal travel itineraries being selected from the feasible travel itineraries based on the ranking.

10. The system of claim 9, wherein the processor is further configured to identify at least one of the feasible travel itineraries for which a budget allocation is unutilized, the budget allocation being associated with the at least one constraint.

11. A method for facilitating optimization-based travel itinerary planning, the method comprising:
receiving, by a processor, a travel-related query from a user;
deriving, by the processor, from the travel-related query, at least one attribute related to the travel-related query and at least one constraint related to the travel-related query;
ranking, by the processor, the at least one attribute based on preference data of the user;
assigning, by the processor, weights to the at least one attribute based on the ranking to create at least one weighted attribute;
associating, by the processor, cost data with the at least one weighted attribute;
scoring, by the processor, feasible travel itineraries based on the at least one weighted attribute and the cost data associated with the at least one weighted attribute; and
selecting, by the processor, from the feasible travel itineraries, based on the at least one constraint, an optimal travel itinerary to be provided to the user.

12. The method of claim 11, further comprising:
parsing the travel-related query, wherein the at least one attribute and at least one constraint are derived from the travel-related query based on the parsing.

13. The method of claim 11, further comprising determining the preference data of the user based on one or more of the following: the travel-related query, preexisting selections associated with the user, and preexisting selections associated with one or more further users.

14. The method of claim 13, further comprising providing a man-machine interface to receive the preexisting selections from the user.

15. The method of claim 11, wherein the at least one constraint includes one or more of the following: a budgetary constraint, a logical constraint, a conditional constraint, and a timing constraint.

16. The method of claim 11, wherein the selecting of the optimal travel itinerary from the feasible travel itineraries is further based on the scoring of the feasible travel itineraries.

17. The method of claim 16, further comprising
ranking the feasible travel itineraries based on the scoring; and
selecting one or more further optimal travel itineraries to be provided to the user, the one or more further optimal travel itineraries being selected from the feasible travel itineraries based on the ranking.

18. The method of claim 17, further comprising identifying at least one of the feasible travel itineraries for which a budget allocation is unutilized, the budget allocation being associated with the at least one constraint.

19. The method of claim 18, further comprising presenting at least the optimal travel itinerary and the at least one of the feasible travel itineraries for which the budget allocation is unutilized to the user.

20. A system for facilitating optimization-based travel itinerary planning, the system comprising:
a processor configured to:
receive a travel-related query from a user;
parse the travel-related query;
based on the parsing, derive, from the travel-related query, at least one attribute related to the travel-related query and at least one constraint related to the travel-related query;
rank the at least one attribute based on preference data of the user;
assign weights to the at least one attribute based on the ranking to create at least one weighted attribute;
associate cost data with the at least one weighted attribute;
score feasible travel itineraries based on the at least one weighted attribute and the cost data associated with the at least one weighted attribute;
select, from the feasible travel itineraries, based on the at least one constraint, an optimal travel itinerary to be provided to the user; and
identify at least one of the feasible travel itineraries for which a budget allocation is unutilized, the budget allocation being associated with the at least one constraint; and
present at least the optimal travel itinerary and the at least one of the feasible travel itineraries for which the budget allocation is unutilized to the user; and
a database communicatively coupled to the processor, the database storing instructions executable by the processor.
